(19) United States
(12) Patent Application Publication
(10) Pub. No.: US 2026/0228654 A1
(43) Pub. Date: Aug. 6, 2026

(54) INFORMATION PROCESSING SYSTEM, INFORMATION PROCESSING METHOD, AND STORAGE MEDIUM

(71) Applicant: HONDA MOTOR CO., LTD., Tokyo (JP)

(72) Inventors: Hideki Sakai, Wako-shi (JP); Shinichi Murakami, Wako-shi (JP); Yuki Murayama, Wako-shi (JP); Yuya Kishimoto, Wako-shi (JP); Kohei Adachi, Tokyo (JP); Hiroki Tanaka, Tokyo (JP)

(21) Appl. No.: 19/457,262

(22) Filed: Jan. 23, 2026

(30) Foreign Application Priority Data
Jan. 31, 2025 (JP) 2025-014469

(51) Int. Cl. G06Q 10/0631; G06Q 10/0639; G06Q 30/0282; G06Q 50/40

(52) U.S. Cl. CPC G06Q 10/063112; G06Q 10/06398; G06Q 30/0282; G06Q 50/40

(57) ABSTRACT

An information processing system includes an estimation unit configured to estimate a level of a driving skill of a driver who drives a vehicle, a determination unit configured to determine a difficulty of a task of transporting a person and/or an article using the vehicle, and a matching processing unit configured to cause an appropriate task to match the driver on the basis of the level and the difficulty.

### CROSS-REFERENCE TO RELATED APPLICATION

This application is based upon and claims the benefit of priority from Japanese Patent Application No. 2025-014469, filed January 31, 2025, the entire content of which is incorporated herein by reference.

### BACKGROUND

### Field of the Invention

The present invention relates to an information processing system, an information processing method, and a storage medium.

### Description of Related Art

A network computer system that determines an optimal boarding position in an on-demand service (for example, a transportation service) and supports a user and a service provider such that they can efficiently meet each other is known (for example, see Published Japanese Translation No. 2017-524195 of the PCT International Publication).

### SUMMARY

However, in the related art, when a task of transporting a person or an article is requested to a driver, a task which is not appropriate for the driver’s driving skill may be allocated, and thus a person or an article may not be efficiently safely transported.

The present invention was made in consideration of the aforementioned circumstances, and an objective thereof is to provide an information processing system, an information processing method, and a storage medium that can efficiently safely transport a person or an article while effectively using various human resources of drivers.

An information processing system, an information processing method, and a storage medium according to the present invention employ the following configurations.

(1) A first example of the present invention is an information processing system including: an estimation unit configured to estimate a level of a driving skill of a driver who drives a vehicle; a determination unit configured to determine a difficulty of a task of transporting a person and/or an article using the vehicle; and a matching processing unit configured to cause an appropriate task to match the driver on the basis of the level and the difficulty.

(2) A second example of the present invention is the information processing system according to the first example, wherein the estimation unit acquires driving data indicating behavior of the vehicle driven by the driver, calculates a score of the driving skill of the driver in each of a plurality of viewpoints on the basis of the driving data, and estimates the level on the basis of the score calculated in each of the plurality of viewpoints.

(3) A third example of the present invention is the information processing system according to the first example or the second example, wherein the determination unit determines the difficulty on the basis of a destination of the person and/or the article, a time required for transportation of the person and/or the article, a distance required for transportation of the person and/or the article, geographic information of a region in which the person and/or the article is transported, weather information of the region in which the person and/or the article is transported, and/or congestion prediction information of the region in which the person and/or the article is transported.

(4) A fourth example of the present invention is the information processing system according to the first example or the second example, wherein the matching processing unit causes a first task to match a first driver and causes a second task of a lower difficulty than that of the first task to match a second driver of a lower level than that of the first driver.

(5) A fifth example of the present invention is information processing system according to the second example, further including a provision unit configured to provide a feedback for improving the score to the driver.

(6) A sixth example of the present invention is the information processing system according to the fifth example, wherein the provision unit selects the viewpoint with the lowest score out of the plurality of viewpoints and provides driving training for improving the score in the selected viewpoint as the feedback to the driver.

(7) A seventh example of the present invention is the information processing system according to the sixth example, wherein the matching processing unit causes the task of a requester to match the driver having completed the driving training designated by the requester of the task.

(8) An eighth example of the present invention is an information processing method using a computer, the information processing method including: estimating a level of a driving skill of a driver who drives a vehicle; determining a difficulty of a task of transporting a person and/or an article using the vehicle; and causing an appropriate task to match the driver on the basis of the level and the difficulty.

(9) A ninth example of the present invention is a non-transitory storage medium storing a program, the program causing a computer to perform: estimating a level of a driving skill of a driver who drives a vehicle; determining a difficulty of a task of transporting a person and/or an article using the vehicle; and causing an appropriate task to match the driver on the basis of the level and the difficulty.

According to the aforementioned examples, it is possible to efficiently safely transport a person or an article while effectively using various human resources of drivers.

### BRIEF DESCRIPTION OF THE DRAWINGS

FIG. 1 is a diagram illustrating an example of a configuration of an information processing system according to an embodiment.

FIG. 2 is a diagram illustrating an example of a configuration of a first terminal device and a second terminal device according to the embodiment.

FIG. 3 is a diagram illustrating an example of a configuration of an information processing device according to the embodiment.

FIG. 4 is a flowchart illustrating an example of a process flow of processes in the information processing device according to the embodiment.

FIG. 5 is a diagram illustrating an example of a driving skill level estimating method.

FIG. 6 is a diagram illustrating an example of a difficulty determining method.

FIG. 7 is a diagram schematically illustrating an inside view of a vehicle.

FIG. 8 is a diagram illustrating an example of an image that is displayed on a first display or a second display at the time of driving training.

FIG. 9 is a diagram illustrating an example of an image that is displayed on the first display or the second display at the time of driving training.

FIG. 10 is a diagram illustrating an example of a screen that is displayed on a first terminal device according to the embodiment.

FIG. 11 is a diagram illustrating an example of a screen that is displayed on the first terminal device according to the embodiment.

### DESCRIPTION OF EMBODIMENTS

Hereinafter, an information processing system, an information processing method, and a storage medium according to an embodiment of the present invention will be described with reference to the accompanying drawings.

### Configuration of information processing system

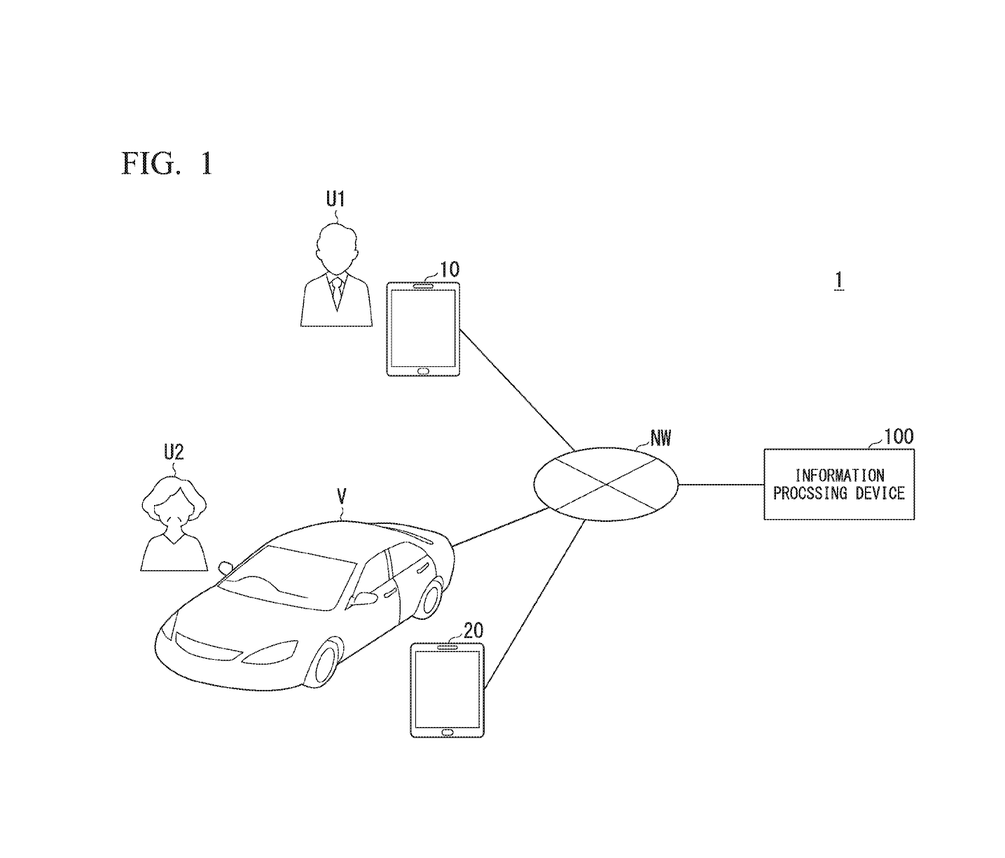

FIG. 1 is a diagram illustrating an example of a configuration of an information processing system 1 according to an embodiment. The information processing system 1 according to the embodiment is a system with which various tasks are requested to another user U2 according to a request from a user U1. The tasks requested to the user U2 include a task of transporting a target object. The target object may be a person or an article.

The information processing system 1 includes, for example, a first terminal device 10, a second terminal device 20, a vehicle V, and an information processing device 100. These devices are connected, for example, via a network (NW) such as a local area network (LAN) or a wide area network (WAN).

The first terminal device 10 may be, for example, a general-purpose device such as a smartphone, a tablet, a personal computer, or a wearable device. The first terminal device 10 is used by a user U1. The first terminal device 10 may be an edge type information processing terminal device.

The user U1 may be an identified individual such as a sole proprietor or may be an organization or an association including a plurality of persons such as a delivery company. The user U1 may be a system or a robot including artificial intelligence (AI).

For example, a task for requesting (offering) the user U2 to transport the user U1 or a family member thereof or requesting the user U2 to transport commodities purchased in a real store or an online store by the user U1 is input to the first terminal device 10. In the following description, a task of transporting a person or an article is particularly referred to as a transportation task. The user U1 is an example of a “requester.”

Similarly to the first terminal device 10, the second terminal device 20 may be, for example, a general-purpose device such as a smartphone, a tablet, a personal computer, a wearable device, or a drive recorder. The second terminal device 20 is used by the user U2. The function of the second terminal device 20 may be incorporated into a car navigation system mounted in the vehicle V or a connected device that can be connected to a network. Similarly to the first terminal device 10, the second terminal device 20 may be an edge type information processing terminal.

The user U2 may be, for example, an identified individual driver such as a sole proprietor or may be a driver working for a delivery company or a combination of a plurality of drivers. The user U2 to whom a transportation task has been requested from the user U1 transports a person or an article using the vehicle V.

The vehicle V may be a vehicle (an owner-driven car) owned by the user U2 or may be a vehicle used in common (a car-sharing vehicle). The vehicle V may be a vehicle rented from a company such as a taxi company or a bus company.

An advanced safety function, an advanced driving support function, and/or an automated driving function may be mounted in the vehicle V. That is, an adaptive cruise control function, a collision mitigation brake system, a lane keep assist system, a parking assist function, a blind spot monitoring function, a road sign recognition system, a drowsy driving sensing system, an automated driving function of levels 1 to 5,or the like may be mounted in the vehicle V.

For example, a screen for selecting whether to accept a request for transportation of a person or an article according to a transportation task input to the first terminal device 10 is displayed on the second terminal device 20. When the user U2 accepts the request and a person or an article is actually transported, a remuneration is paid to the user U2 (an incentive is given).

The information processing device 100 acquires driving data of the user U2 from the vehicle V or the second terminal device 20 via a network and performs leveling of a driving skill of the user U2 on the basis of the driving data. That is, the information processing device 100 estimates a level of the driving skill (hereinafter referred to as a driving skill level) of the user U2. The information processing device 100 may be a cloud type information processing device.

The information processing device 100 may estimate the driving skill level of the user U2 on the basis of healthcare data of the user U2 in addition to the driving data of the user U2. The healthcare data includes healthcare data before and after driving as well as during driving of the user U2. Specifically, the healthcare data may include a heart rate, a blood pressure, a stress level, sleep data, blood oxygen saturation, temperature, an amount of activity, brainwave data, and a medical checkup result.

The information processing device 100 may estimate the driving skill level of the user U2 on the basis of equipment of the vehicle V of the user U2 in addition to the driving data of the user U2. The equipment of the vehicle V may be, for example, an erroneous depression prevention device for an accelerator pedal or a brake pedal or a driving support device.

The driving data includes, for example, data on behavior or states of the vehicle V when the vehicle V is driven by the user U2. Specifically, the driving data may include a rotation speed of an engine, a state of charge of a secondary battery, an amount or frequency of operation (an amount of depression) of the accelerator pedal, an amount or frequency of operation (an amount of depression) of the brake pedal, an amount or frequency of operation of a steering wheel, or a speed, acceleration, or jerk of the vehicle V.

The driving data may include data from various sensors (such as a camera, a radar, an LIDAR, or a GNSS receiver) provided to activate the driving support function or the automated driving function. Specifically, the driving data may include various types of information such as a front-view image, a rear-view image, or a side-view image of the vehicle V, a distance (a vehicle-to-vehicle distance) to another vehicle near the vehicle V, and position information.

The information processing device 100 acquires task information from the first terminal device 10 via the network and determines a difficulty of the transportation task requested to the user U2 on the basis of the task information.

The task information is information which is input as the transportation task to the first terminal device 10. For example, the task information includes a destination of a person or an article, a time (time limit) required for transportation, a distance (traveling distance) required for transportation, geographic information of a region in which a person or an article is transported, weather information of the region in which the person or the article is transported, and/or congestion prediction information of the region in which the person or the article is transported. The geographic information may include, for example, an elevation, the number of slopes or inclination angles thereof, the number of winding roads, a width of each road, information indicating whether each road is paved, a traffic volume, an amount of snowfall, information indicating whether each road is flooded, information indicating whether there is a school, and information indicating whether there is a school walkway.

The information processing device 100 causes an appropriate transportation task to match the user U2 on the basis of the difficulty of the transportation task and the driving skill level of the user U2.

### Configuration of terminal device

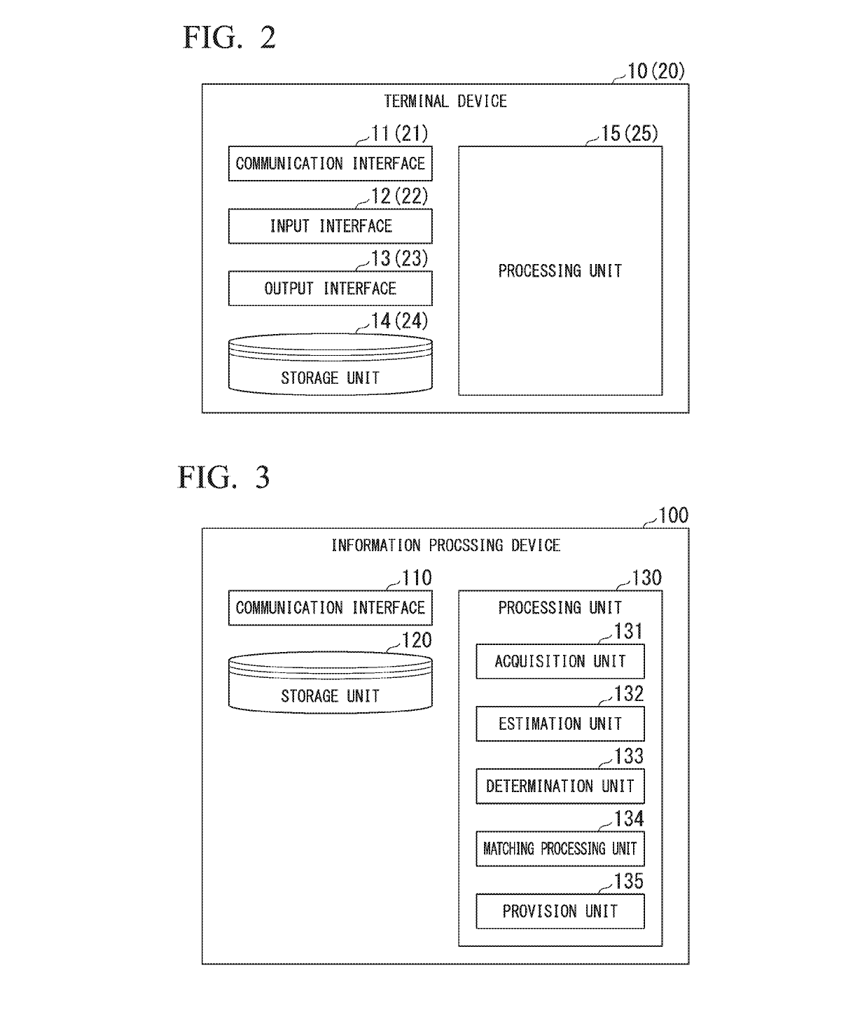

FIG. 2 is a diagram illustrating an example of a configuration of the first terminal device 10 and the second terminal device 20 according to the embodiment. Since the configurations of these terminal devices are the same, the first terminal device 10 will be representatively described. That is, the constituents of the first terminal device 10 may be appropriately replaced with the constituents of the second terminal device 20. Reference signs in parentheses) denote the constituents of the second terminal device 20.

The first terminal device 10 (20) includes, for example, a communication interface 11 (21), an input interface 12 (22), an output interface 13 (23), a storage unit 14 (24), and a processing unit 15 (25).

The communication interface 11 includes, for example, a network interface card (NIC) or a wireless communication module including a receiver and a transmitter. The communication interface 11 communicates with the information processing device 100 via the network.

The input interface 12 receives various input operations from a user, converts a received input operation to an electrical signal, and outputs the electrical signal to the processing unit 15. For example, the input interface 12 includes a mouse, a keyboard, a track ball, a switch, a button, a joystick, or a touch panel. The input interface 12 may be, for example, an audio user interface that receives a voice input including a microphone.

The output interface 13 includes, for example, a display or a speaker. The display displays an image generated by the processing unit 15, a graphical user interface (GUI) for receiving various input operations from a user, or the like. For example, the display is a liquid crystal display (LCD) or an organic electroluminescence (EL) display. The speaker outputs information input from the processing unit 15 as sound. When the input interface 12 is a touch panel, the input interface 12 and the output interface 13 may be formed as a unified body.

The storage unit 14 is realized, for example, by a hard disc drive (HDD), a flash memory, an electrically erasable programmable read only memory (EEPROM), a read only memory (ROM), or a random access memory (RAM). The storage unit 14 stores firmware, an application program, or the like.

The processing unit 15 is realized, for example, by causing a processor such as a central processing unit (CPU) or a graphics processing unit (GPU) to execute a program stored in the storage unit 14. The processing unit 15 may be realized by hardware such as a large scale integration (LSI) circuit, an application specific integrated circuit (ASIC), a field-programmable gate array (FPGA), or a system on chip (SOC) or may be cooperatively realized by software and hardware.

### Configuration of information processing device

A configuration of the information processing device 100 will be described below. The information processing device 100 may be a single device or may be a system in which a plurality of devices connected via a network operate cooperatively. That is, the information processing device 100 may be realized by a plurality of computers (processors) included in a distributed computing system or a cloud computing system.

FIG. 3 is a diagram illustrating an example of a configuration of the information processing device 100 according to the embodiment. The information processing device 100 includes, for example, a communication interface 110, a storage unit 120, and a processing unit 130.

The communication interface 110 includes, for example, an NIC or a wireless communication module including a receiver and a transmitter. The communication interface 110 communicates with the first terminal device 10 and the second terminal device 20 via the network.

The storage unit 120 is realized, for example, by an HDD, a flash memory, an EEPROM, a ROM, or a RAM. The storage unit 120 stores firmware or an application program.

The processing unit 130 includes, for example, an acquisition unit 131, an estimation unit 132, a determination unit 133, a matching processing unit 134, and a provision unit 135. These constituents of the processing unit 130 are realized, for example, by causing a processor such as a CPU or a GPU to execute a program stored in the storage unit 120. Some or all of the constituents of the processing unit 130 may be realized by hardware such as an LSI, an ASIC, an FPGA, or an SOC or may be cooperatively realized by software and hardware.

### Process flow in information processing device

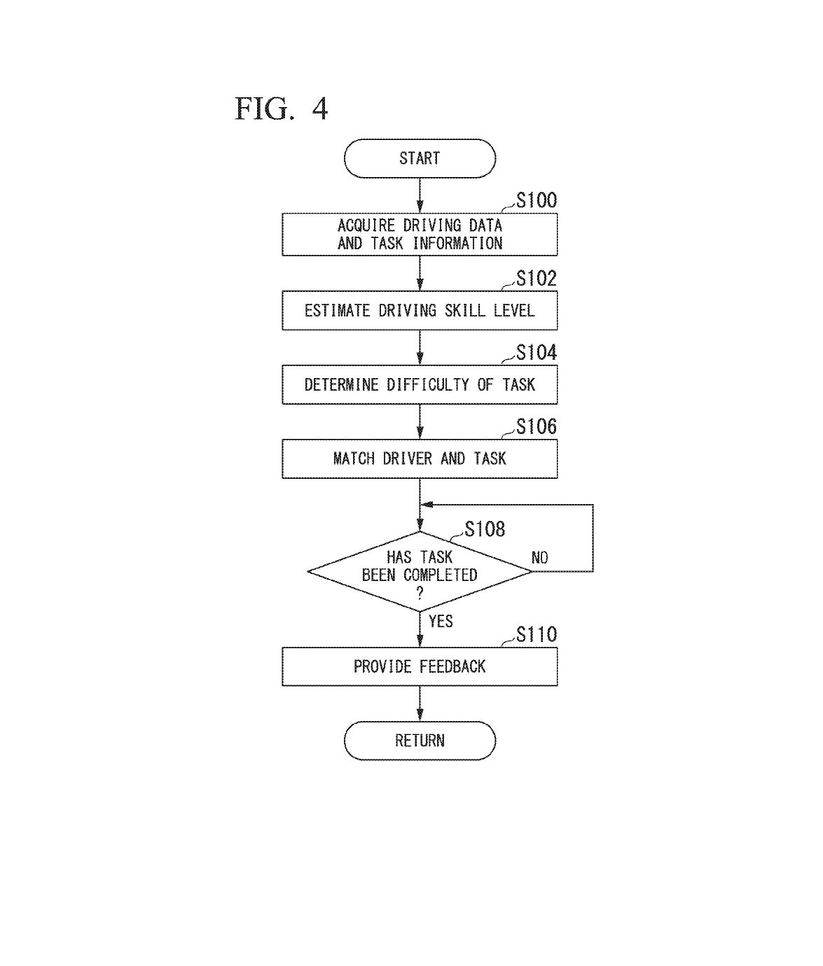

A process flow that is performed by the constituents of the processing unit 130 will be described below with reference to a flowchart. FIG. 4 is a flowchart illustrating an example of a process flow of processes in the information processing device 100 according to the embodiment. The process flow of the flowchart may be repeatedly performed, for example, at intervals of a predetermined period.

First, the acquisition unit 131 acquires driving data of the vehicle V driven at least once by the user U2 and task information (Step S100).

As described above, the driving data includes data on behavior or a state of the vehicle V and data from sensors provided to activate the driving support function or the automated driving function. The task information includes a destination of a person or an article, a time (time limit) required for transportation, a distance (traveling distance) required for transportation, and/or geographic information of a region in which a person or an article is transported.

For example, the acquisition unit 131 may access the vehicle V via the communication interface 110 and acquire driving data from the vehicle V.

Similarly, the acquisition unit 131 may access the first terminal device 10 via the communication interface 110 and acquire task information from the first terminal device 10.

When the driving data or the task information is stored in a cloud server connected thereto via the network, the acquisition unit 131 may access the cloud server via the communication interface 110 and acquire the driving data or the task information from the cloud server.

Then, the estimation unit 132 estimates the driving skill level of the user U2 on the basis of the driving data of the user U2 (Step S102).

For example, the estimation unit 132 calculates a score of the driving skill of the user U2 in each of a plurality of viewpoints and estimates the driving skill level on the basis of the score in each viewpoint.

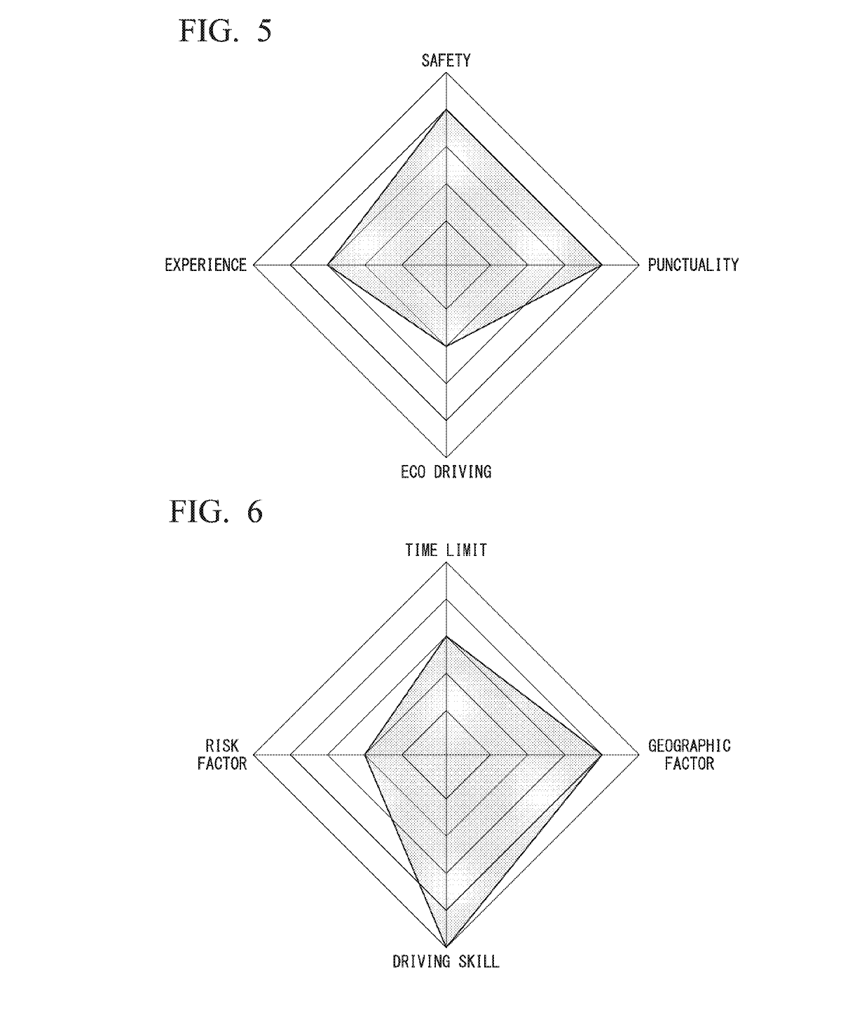

FIG. 5 is a diagram illustrating an example of a driving skill level estimating method. As illustrated in the drawing, the plurality of viewpoints may include, for example, safety, punctuality, eco driving, and experience, and the score is calculated in each viewpoint.

For example, in the viewpoint of safety, the estimation unit 132 acquires sudden acceleration, sudden deceleration, sudden steering (sudden turning), and the number of times of overspeed and sums and evaluates weighted scores set for the items.

Specifically, the estimation unit 132 decreases the score in such a manner as minus 5 points per sudden acceleration and minus 3 points per overspeed and calculates the score of safety out of 100.

In the viewpoint of punctuality, the estimation unit 132 calculates the score by decreasing the score in such a manner as minus 2 points per minute of delay on the basis of a difference between a scheduled arrival time and an actual time in transportation of an article or a person.

In the viewpoint of eco driving, the estimation unit 132 calculates a level of fuel efficiency or electric mileage as a score on the basis of fuel efficiency data or idling time of the vehicle V. Specifically, the estimation unit 132 calculates the score of eco driving by increasing the score in such a manner as plus 5 points when the fuel efficiency or the electric mileage is better by 10% than a reference value or decreasing the score in such a manner as minus 5 points when the idling time is long.

In the viewpoint of experience, the estimation unit 132 calculates the score on the basis of a total traveling distance in the past, the number of times of task completion, and an accident or violation history.

The estimation unit 132 estimates the scores calculated in the viewpoints as the driving skill level. For example, the driving skill level is scored in such a manner as 85 points in safety, 90 points in punctuality, 80 points in eco driving, and 95 points in experience.

As described above, the estimation unit 132 may estimate the driving skill level of the user U2 on the basis of healthcare data of the user U2 in addition to the driving data of the user U2 or may estimate the driving skill level of the user U2 on the basis of equipment of the vehicle V of the user U2. For example, when the user U2 is an aged driver and the driving skill level of the user U2 is estimated to be “low” from the driving data thereof but when the vehicle V of the user U2 is equipped with an erroneous depression prevention device, the driving skill may be raised from “low” to “middle.”

Then, the determination unit 133 determines a difficulty of the transportation task requested to the user U2 from the user U1 on the basis of the task information (Step S104).

FIG. 6 is a diagram illustrating an example of a difficulty determining method. As illustrated in the drawing, the determination unit 133 may determine the difficulty of the transportation task on the basis of time limit, a geographic factor, a driving skill, and a risk factor.

For example, in the field of physical distribution, there may be a task of transporting a high-price device in emergency. In this transportation task, the time limit (arrival within designated time) is higher, the geographic factor is complicated (a route including a congestion predicted area), and a high driving skill (a precise driving skill for reducing vibration of the device) is required. Accordingly, the difficulty of the task of transporting a high-price device in emergency is determined to be high.

On the other hand, in the field of people distribution, there may be a task of causing an inexperienced driver to transport a passenger in a short distance. In this transportation task, the time limit is low, the geographic factor is flat and simple, a high driving skill is not required. Accordingly, the difficulty of the task of causing an inexperienced driver to transport a passenger in a short distance is determined to be low.

These difficulties may be converted to numerical values on the basis of a weight reference which is set in advance. For example, a score of 1 to 5 is given to “time limit” such that the score increases as a delay risk increase. Similarly, in the geographic factor, the score increases on a mountain road, a rough road, or an urban congestion area. The determination unit 133 may sum the scores of the factors and determine the difficulty in three stages of “low, middle, and high” on the basis of threshold values or determine the difficulty in five or more stages.

Then, the matching processing unit 134 causes an appropriate transportation task to match the user U2 on the basis of the difficulty of the transportation task and the driving skill level of the user U2 (Step S106).

For example, the matching processing unit 134 causes a transportation task Ta with a high difficulty to match a user U2-1 with a high driving skill level and causes a transportation task Tb with a lower difficulty than that of the transportation task Ta to match a user U2-2 with a lower driving skill level than that of the user U2-1. The user U2-1 is an example of a “first driver,” and the user U2-2 is an example of a “second driver,” the transportation task Ta is an example of a “first task,” and the transportation task Tb is an example of a “second task.”

More specifically, it is assumed that a delivery company has two tasks of “delivery of a precise device to an urban area with designated time (high difficulty)” and “delivery of documents to a suburban area (low difficulty).” The matching processing unit 134 causes the “delivery of a precise device to an urban area with designated time” which is a transportation task with a high difficulty in the former to match the user U2-1 with a high driving skill level and causes the “delivery of documents to a suburban area” which is a transportation task with a low difficulty in the latter to match the user U2-2 with a lower driving skill level than the user U2-1. Accordingly, it is possible to enhance the success probability of tasks and to efficiently transport a person or an article while minimizing a risk.

Then, the provision unit 135 waits until the transportation task matching the user U2 is completed (Step S108) and provides a feedback for improving the driving skill level to the second terminal device 20 used by the user U2 via the communication interface 110 or provides the feedback to the vehicle V used by the user U2 when the transportation task is completed (Step S110).

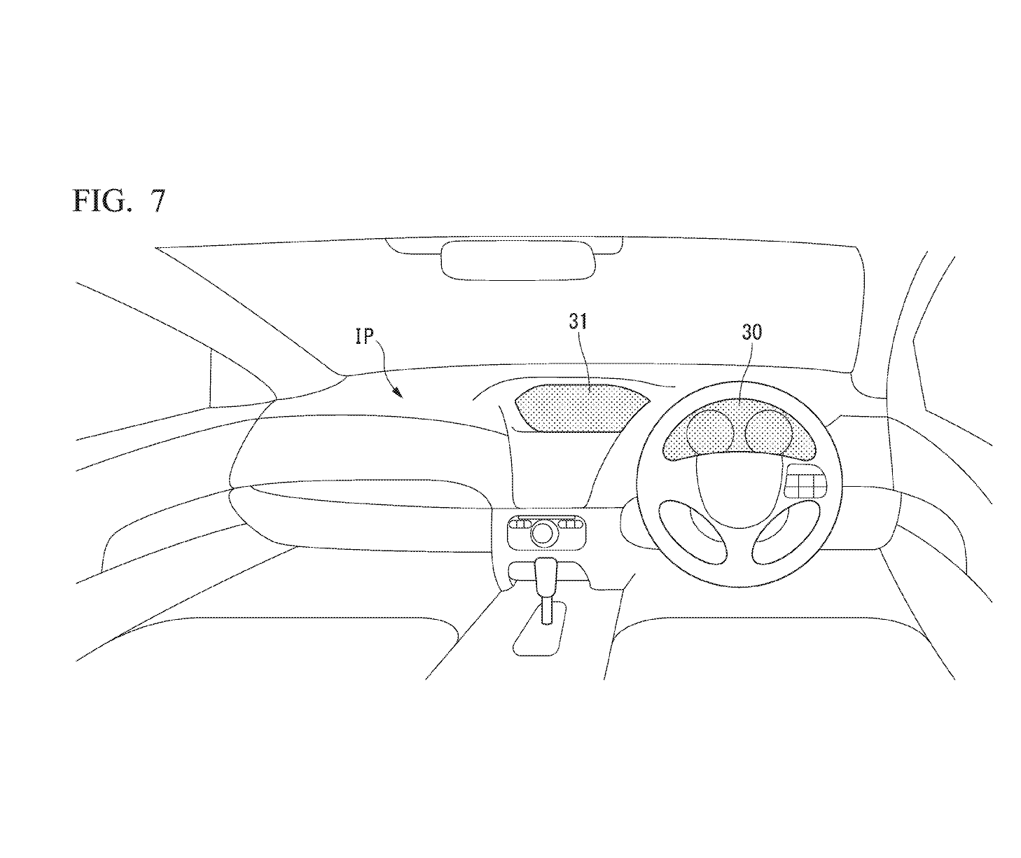

FIG. 7 is a diagram schematically illustrating an inside view of the vehicle V. For example, a first display 30 is provided in the vicinity of the front of a driver’s seat (a seat closest to the steering wheel) in an instrument panel IP. The first display 30 is installed at a position at which it can be seen via a gap of the steering wheel by a driver or it can be seen over the steering wheel by the driver.

The first display 30 is, for example, an LCD or an organic EL display device. For example, a speed, an engine rotation speed, a fuel residual, a radiator temperature, a traveling distance, and a battery residual capacity of the vehicle V are displayed on the first display 30. For example, a future trajectory of the vehicle V, information indicating whether to change a lane and a lane which is a destination of lane change, a recognized lane (marking line), other vehicles, or the like may be displayed on the first display 30.

A second display 31 is provided in the vicinity of the center of the instrument panel IP. Similarly to the first display 30, for example, the second display 31 is an LCD or an organic EL display device. For example, the second display 31 displays a route which is guided by a navigation device, displays a television program, displays content reproduced from a DVD, or displays content downloaded via the network.

For example, it is assumed that the scores calculated in the plurality of viewpoints in the course of estimating the driving skill level of the user U2 are evaluated as “many sudden acceleration (-10 points),” “three times of overspeed (-15 points),” and “fuel efficiency lower than a reference value (-8 points).” In this case, the provision unit 135 may display improvements of “safety (avoidance of sudden acceleration)” and “eco driving” as the feedback on the first display 30 or the second display 31.

For example, the provision unit 135 may select a viewpoint with the lowest score out of the plurality of viewpoints of which the score has been calculated and display driving training for improving the score in the selected viewpoint as the feedback on the first display 30 or the second display 31.

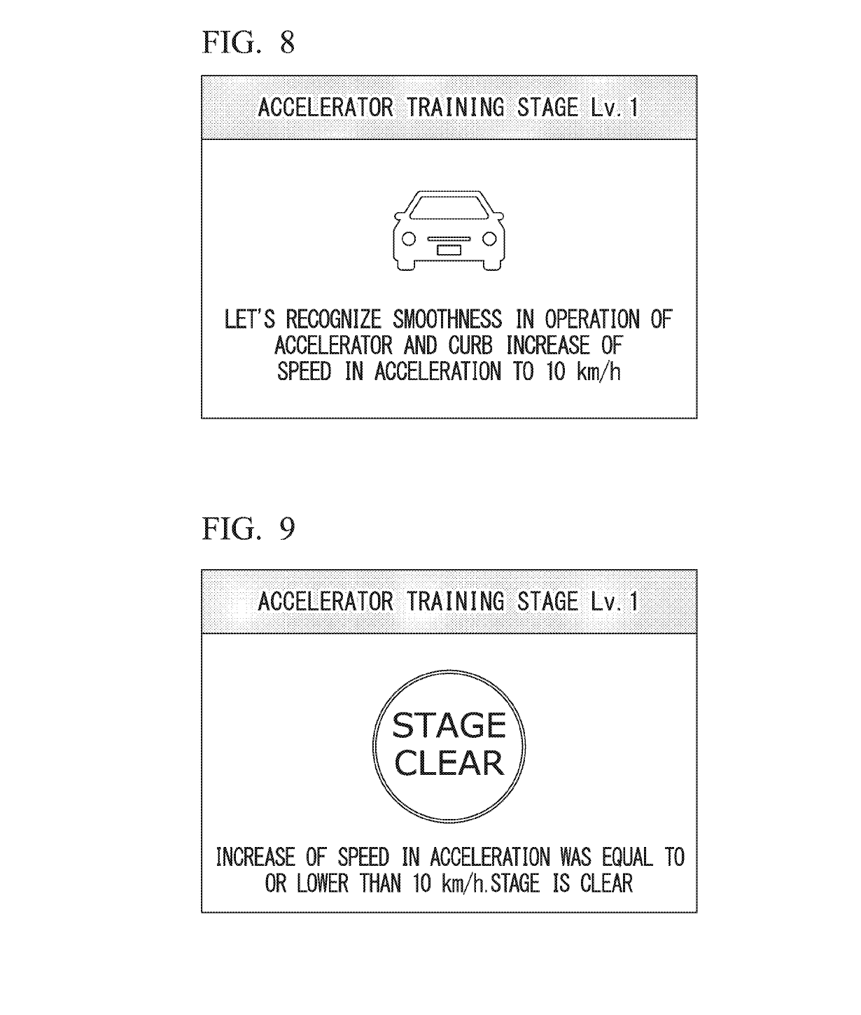

FIGS. 8 and 9 are diagrams illustrating an example of an image displayed on the first display 30 or the second display 31 at the time of driving training. As illustrated in FIG. 8, specific coaching such as “Let’s recognize smoothness of an accelerator operation and curb a speed increase in acceleration to, for example, 10 [km/h] or lower per second” may be displayed in order to curb sudden acceleration in an accelerator training stage For example, it is assumed that the user U2 has driven the vehicle V while curbing the speed increase in acceleration to 10 [km/h] or lower per second in accordance with the accelerator training. In this case, information indicating that the accelerator training stage is clear is displayed on the first display 30 or the second display 31. An advance such as “20% decrease of sudden acceleration in this month from that of the previous month” or “5-point improvement of the eco driving score” may also be displayed, or an incentive may be given to the user U2 according to an achievement level of the training stage. In this way, by visualizing the growth of the driving skill of the driver, it is possible to continuously improve motivation of the driver to improve the driving skill level in the sense of a game.

According to the aforementioned embodiment, the information processing device 100 estimates a driving skill level of a user U2 who drives the vehicle V and determines the difficulty of a transportation task. The information processing device 100 causes an appropriate transportation task to match the user U2 on the basis of the driving skill level and the difficulty of the transportation task. With this configuration, it is possible to efficiently safely transport a person or an article while effectively using various human resources of drivers.

### Modified examples of embodiment

Modified examples of the embodiment will be described below. In the aforementioned embodiment, matching of the user U2 and the transportation task is performed on the basis of the driving skill level and the difficulty of the transportation task, but the present invention is not limited thereto. For example, the matching processing unit 134 may perform matching of the user U2 and the transportation task on the basis of an achievement level of driving training in addition to the driving skill level and the difficulty of the transportation task.

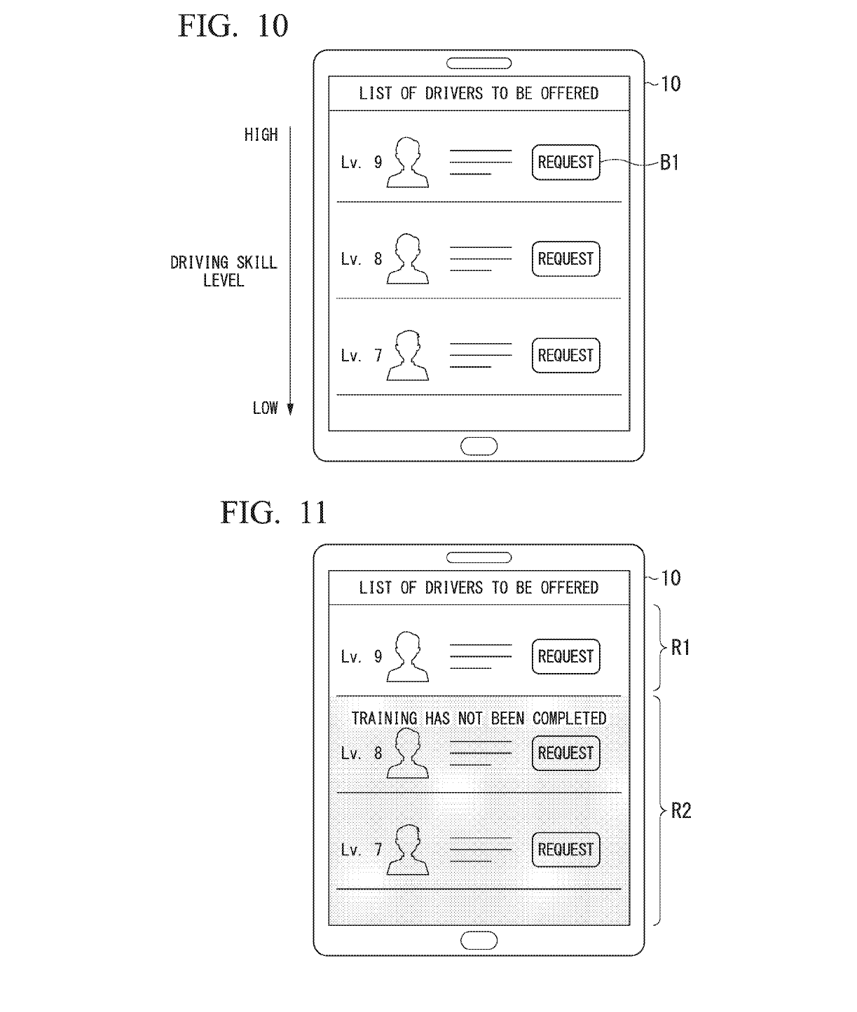

Matching based on an achievement level of driving training will be described below with reference to some drawings. FIGS. 10 and 11 are diagrams illustrating an example of a screen which is displayed on the first terminal device 10 according to the embodiment.

As illustrated in FIG. 10, a list of a plurality of drivers to which a transportation task can be requested is displayed on the screen of the first terminal device 10. At this time, a driver with a higher driving skill level may be displayed at a higher position on the screen. A request button (a button B1 on the screen) is assigned to each driver. For example, when the user U1 operates the request button of the uppermost driver on the screen, the transportation task to the uppermost driver on the screen is transmitted from the first terminal device 10 to the information processing device 100.

As illustrated in FIG. 11, the screen of the first terminal device 10 may include an active region R1 and a non-active region R2. The active region R1 is a region in which an operation of the user U1 is validated (enable) and only a driver having achieved predetermined driving training designated by the user U1 who is a requester of the transportation task (or a driver whose an achievement level is equal to or higher than a threshold value) is displayed. The non-active region R2 is a region in which the operation of the user U1 is invalidated (disable) and a driver not having achieved the predetermined driving training still (or a driver whose an achievement level is less than the threshold value) is displayed. In this way, the transportation task may be caused to match only a driver having achieved the predetermined driving training designated by the user U1.

In the aforementioned embodiment, the information processing device 100 may convert the driving skill of the user U2 to scores in more viewpoints in real time, acquire a progress situation of the transportation task, or reflect a feedback after the transportation task has been completed. The information processing device 100 may improve matching accuracy using machine learning. The information processing device 100 may cope with dynamic adjustment of priority or business resources and to flexibly cope with any sudden business request. Accordingly, it is possible to realize optimal business assignment based on a driving skill and to achieve an increase in efficiency of physical distribution and human distribution and an improvement in safety.

While a mode for carrying out the present invention has been described above in conjunction with an embodiment, the present invention is not limited to the embodiment, and various modifications and substitutions can be added without departing from the gist of the present invention.

What is claimed is:

1. An information processing system comprising:
an estimation unit configured to estimate a level of a driving skill of a driver who drives a vehicle;
a determination unit configured to determine a difficulty of a task of transporting a person and/or an article using the vehicle; and
a matching processing unit configured to cause an appropriate task to match the driver on the basis of the level and the difficulty.

2. The information processing system according to claim 1, wherein the estimation unit performs:
acquiring driving data indicating behavior of the vehicle driven by the driver;
calculating a score of the driving skill of the driver in each of a plurality of viewpoints on the basis of the driving data; and
estimating the level on the basis of the score calculated in each of the plurality of viewpoints.

3. The information processing system according to claim 1, wherein the determination unit determines the difficulty on the basis of a destination of the person and/or the article, a time required for transportation of the person and/or the article, a distance required for transportation of the person and/or the article, geographic information of a region in which the person and/or the article is transported, weather information of the region in which the person and/or the article is transported, and/or congestion prediction information of the region in which the person and/or the article is transported.

4. The information processing system according to claim 1, wherein the matching processing unit performs:
causing a first task to match a first driver; and
causing a second task of a lower difficulty than that of the first task to match a second driver of a lower level than that of the first driver.

5. The information processing system according to claim 2, further comprising a provision unit configured to provide a feedback for improving the score to the driver.

6. The information processing system according to claim 5, wherein the provision unit performs:
selecting the viewpoint with the lowest score out of the plurality of viewpoints; and
providing driving training for improving the score in the selected viewpoint as the feedback to the driver.

7. The information processing system according to claim 6, wherein the matching processing unit causes the task of a requester to match the driver having completed the driving training designated by the requester of the task.

8. An information processing method using a computer, the information processing method comprising:
estimating a level of a driving skill of a driver who drives a vehicle;
determining a difficulty of a task of transporting a person and/or an article using the vehicle; and
causing an appropriate task to match the driver on the basis of the level and the difficulty.

9. A non-transitory storage medium storing a program, the program causing a computer to perform:
estimating a level of a driving skill of a driver who drives a vehicle;
determining a difficulty of a task of transporting a person and/or an article using the vehicle; and
causing an appropriate task to match the driver on the basis of the level and the difficulty.
